(19) United States
(12) Patent Application Publication
(10) Pub. No.: US 2006/0250249 A1
(43) Pub. Date: Nov. 9, 2006

(54) Self describing RFID chains to validate parts in bills-of-material or manifest when disconnected from server

(75) Inventor: Wesley Cheng, Palo Alto, CA (US)

Correspondence Address: TRAN & ASSOCIATES, 6768 MEADOW VISTA CT., SAN JOSE, CA, 95135, US

(73) Assignee: KONAWARE, INC.

(21) Appl. No.: 11/399,550

(22) Filed: Apr. 5, 2006

Related U.S. Application Data
(60) Provisional application No. 60/669,763, filed on Apr. 8, 2005.
(60) Provisional application No. 60/671,284, filed on Apr. 13, 2005.

(51) Int. Cl. G08B 13/14

(52) U.S. Cl. 340/572.4

(57) ABSTRACT

Systems and methods are disclosed to track items transported in a container having a network; first and second home servers coupled to the network and communicating with first and second wireless nodes, respectively, wherein the first node is authorized to communicate with the first home server and the second node is authorized to communicate with the second home server; the first node caching relationships among one or more items of the container by writing the relationships on a memory attached to that container; shipping the container to a destination; and at the second node, scanning the memory to determine whether the transported one or more items arrived at the destination; a registration server coupled to the network and adapted to assign the first node to the first home server and the second node to the second home server; and an enterprise computer coupled to the network to query the nodes.

This application claims priority to Provisional Application Ser. No. 60/669,763 filed Apr. 8, 2005 and Provisional Application Ser. No. 60/671,284 filed Apr. 13, 2005, the contents of which are incorporated by reference.

The present invention relates generally to radio frequency identification (RFID) systems.

In recent years, radio frequency identification (RFID) systems have been employed in an ever increasing range of applications. For example, RFID systems have been used in supply chain management applications to identify and track merchandise throughout manufacture, warehouse storage, transportation, distribution, and retail sale. RFID systems have also been used in security applications to identify and track personnel for controlling access to restricted areas of buildings and plant facilities, thereby prohibiting access to such areas by individuals without the required authorization. Accordingly, RFID systems have been increasingly employed in diverse applications to facilitate the identification and tracking of merchandise, personnel, and other items and/or individuals that need to be reliably monitored and/or controlled within a particular environment.

Assets with the tags are typically shipped inside a container. The container could be a box, a shipping container, a cardboard package, a warehouse, a train car, a vehicle, for example. The container is anything that contains a set of other objects. For example, a container might consist of boxes that contain smaller boxes of a particular type of product. It might be fixed or movable. The contents of a container are difficult to ascertain for accuracy because the information is not stored on some kind of memory that can easily be accessed and validated. During its transit or at periodic inspections, one cannot determine if pieces have been added or deleted to the container, which might constitute serious security breaches. Today, the information is stored on the systems of different vendors (such as OEM suppliers, the manufacturers, the distributors) which cannot be easily accessed and used for validation. Even if the information is available from a central or distributed system, the device scanning the information from the container needs to have a connection to that system, which is both inefficient, slow and sometimes not possible (such as when the container is on a ship, or train, or dock with no wireless or wired network).

When a shipment arrives at a location, a typical RFID reader would pick up each tag's top-level item and their sub-components. In the example shown in FIG. 1, the following identification tags are scanned to produce the following list:

1. 1

2. 1.1

3. 1.1.1

4. 1.1.2

5. 1.1.3

6. 1.1.4

7. 1.1.5

8. 1.1.6

9. 1.2

10. 1.2.1

11. 1.2.2

12. 1.2.3

13. 1.2.4

14. 1.2.5

15. 1.2.6

16. 1.3

17. 1.3.1

18. 1.3.2

19. 1.3.3

20. 1.3.4

21. 1.4

22. 1.4.1

23. 1.4.2

24. 2

25. 2.1

26. 2.1.1

27. 2.1.2

28. 2.1.3

29. 2.1.4

30. 2.1.5

31. 2.1.6

32. 2.2

33. 2.2.1

34. 2.2.2

35. 2.2.3

36. 2.2.4

37. 2.2.5

38. 2.2.6

39. 2.3

40. 2.3.1

41. 2.3.2

42. 2.3.3

43. 2.3.4

44. 2.4

45. 2.4.1

46. 2.4.2

47. 3

48. 3.1

49. 3.2

50. 3.2.1

51. 3.2.1.1

52. 3.2.1.1.1

Since there is no information available on the relationship among the components in the RFID tag, the RFID reader must receive a list of all tags from a centralized server and compare the list against the list of scanned components. This requires the server to determine what tags were not sent, which is wasteful and less scalable than retrieving the list and performing the comparison on the client side. This technique is inefficient, requiring substantial network bandwidth as well as a powerful server to handle multiple shipments since there could be thousands of components on the list. If the client device cannot handle a large list due to resource constraints, the situation is even worse, since each tag would need to be sent to the server, with validation performed on the server side.

Even if sufficient server- and client-side resources are available, it is still necessary to have the capability to transmit and receive to and from the server. This connectivity is not always available or conveniently available in settings where shipment validation is desirable, such as docks and warehouses and even during transit on ships, aircraft, and trucks.

### BRIEF DESCRIPTION OF THE DRAWINGS

FIG. 1 shows a conventional RFID manifest specifying shipped items or components.

FIG. 2 shows an exemplary process to create an electronic bill of material (eBOM).

FIG. 3 shows exemplary RFID reader portals.

FIG. 4 shows an exemplary placement of tags on an item.

FIG. 5 shows an exemplary eBOM tag format.

FIG. 6 shows an exemplary eManifest tag format.

FIG. 7 shows an exemplary process for performing item validation.

FIG. 8 shows an exemplary sorting process.

FIG. 9 shows exemplary RFID codes in a hash table.

FIG. 10 shows exemplary scan data entered into the hash table.

FIG. 11 shows exemplary elements from an eBOM entered into the hash table.

FIG. 12 shows an example of results after a resolution of scan data and elements from the eBOM.

FIG. 13 is a block diagram illustrating the components of an exemplary mobile RFID system.

FIG. 14 shows an exemplary mobile RFID system with nodes communicating over a wireless network.

### SUMMARY

In another aspect, a system is disclosed to cache relationships among contents of a container by writing them onto memory attached to that container. In one embodiment, when a shipment is assembled, each individual top level component is scanned for its subcomponents. The relationships are written onto a tag (eBOM) attached to the component. Then all the components are aggregated into one shipment and the top level components are written onto another tag (eManifest, or electronic Manifest) that is attached to the shipment (such as a pallet or a shrink-wrapped package).

In another aspect, the system validates shipments of goods. To validate a shipment, the system verifies that all items shipped are present and accounted for, or to list those items not present if such is the case. In one embodiment, a shipment can include top-level items and optionally, hierarchically organized sub-components of the items. The hierarchy can be mirrored by the physical arrangement of the items (e.g., parts in a machine, pieces in a box), but could also be a logical or arbitrary assignment depending on the needs of the parties involved.

In yet another aspect, the system includes a self-describing hierarchical RFID tag structure, linked-list data structures across multiple RFID tags, a single-pass algorithm for validating a shipment as it moves through a RFID scanning portal, exception handling for managing RFID tag read failures, and data structures for managing electronic bills of materials and electronic shipping manifests.

In yet another aspect, systems and methods are disclosed to track items transported in a container having a network; first and second home servers coupled to the network and communicating with first and second wireless nodes, respectively, wherein the first node is authorized to communicate with the first home server and the second node is authorized to communicate with the second home server; the first node caching relationships among one or more items of the container by writing the relationships on a memory attached to that container; shipping the container to a destination; and at the second node, scanning the memory to determine whether the transported one or more items arrived at the destination; a registration server coupled to the network and adapted to assign the first node to the first home server and the second node to the second home server; and an enterprise computer coupled to the network to query the nodes.

Advantages of the system may include one or more of the following. The system eliminates the need for connectivity to a server for validation, and furthermore will reduce the number of tags to validate to just the top level items. The system provides self-describing top-level item tags and an electronic manifest that travels with the shipment. As a result, there is no need to go to the server to validate the integrity of the shipment. All the information is self contained (i.e., managed locally with the shipment itself). The system enables mobile tracking where there is no connectivity to the server. When a container is being inspected or unloaded, the tags can be scanned and validated if it has been compromised (eg. component was damaged or stolen, component was added without authorization). This can be done without any connectivity to the server and can be determined by a handheld device. The system reduces or eliminates problems associated with lack of visibility into supply chains that can result in inefficient production planning, poor customer service, and lost, misplaced, and misdirected items. It also reduces the substantial cost of locating assets across multiple modes of transportation, intermediate storage, and permanent storage. The system provides methods, procedures, and enhancements that yield the maximum amount of detail and accuracy, and reliability on asset location and status. The system supports identifying and tracking tagged merchandise, personnel, and other items and/or individuals within an RFID environment with increased reliability.

### DESCRIPTION

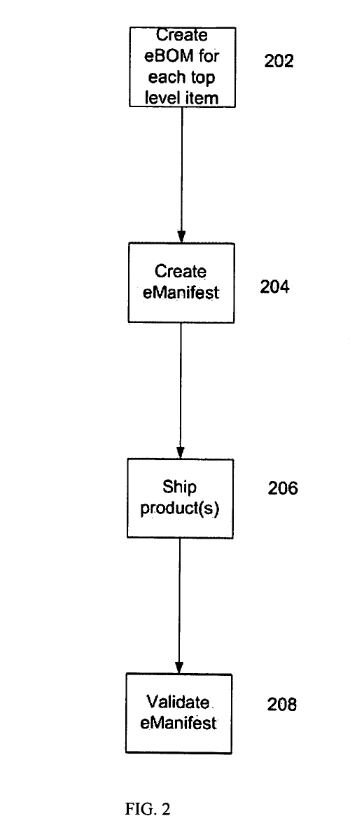

FIG. 2 shows an exemplary process to create an electronic bill of material (eBOM). The process creates an eBOM for each top level item (202). In one implementation, the process adds a writable RFID tag that is added to each top level item. The tag is ideally physically affixed to the item itself. This will increase the cost of the item only slightly while dramatically reducing the networking and server costs. This tag is called the eBOM (electronic Bill-of-Materials) tag and stores a list of the identifiers of the item and its subcomponents. In one embodiment, the process does not store the hierarchical relationship among the various subcomponents because all that is required is to ensure that all the subcomponents are accounted for. Therefore, in this embodiment, the eBOM simply contains a flat list of the subcomponents. Hiearchical relationship can be used in other embodiments of the eBOM.

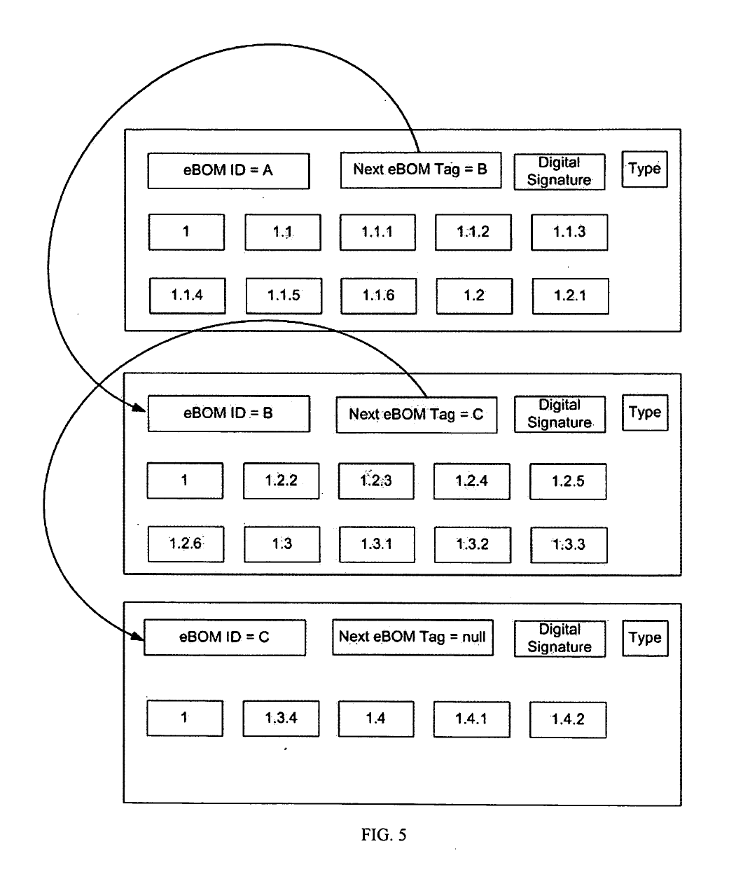

To generate the eBOM for an item, if an item's list of subcomponents is not readily available on the server (for instance, because the item might be made up of sub-assemblies containing components from various vendors that are not easily available from a single server), it can be easily generated by placing the item through an RFID reader portal to scan all the tags and record them into the eBOM tag. This technique also allows an eBOM tag to be generated when no connection to the server is available, which may be desirable in some circumstances. One embodiment of the eBOM format is shown in FIG. 5.

Next, the process creates an eManifest (electronic manifest), which contains a list of all the top-level items in the shipment (204). This is done by packaging the items and sending them through the RFID reader portal, which picks up the top level items from the eBOMs and writes them onto the eManifest tag. The next step in the process is to ship the product(s) (206). The shipment is assumed to survive shipment and not be broken up during transit.

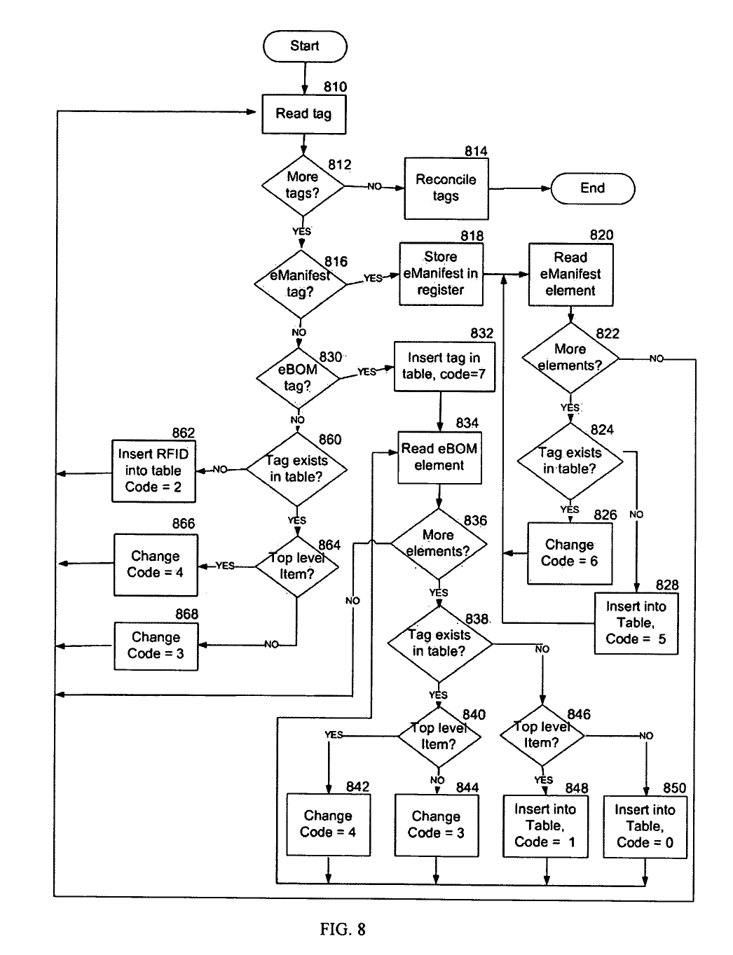

The process validates the shipment to determine which items of the shipment are still present and which are missing (208). This may be done at any time: during shipping, at a stopping point, at the destination, or at a storage location, for instance. Because the necessary information is stored in RFID tags with the shipment, no connection to a central server or DB is required. As described in FIG. 8, this validation process scans all RFIDs and assembles them into a hash table for accounting.

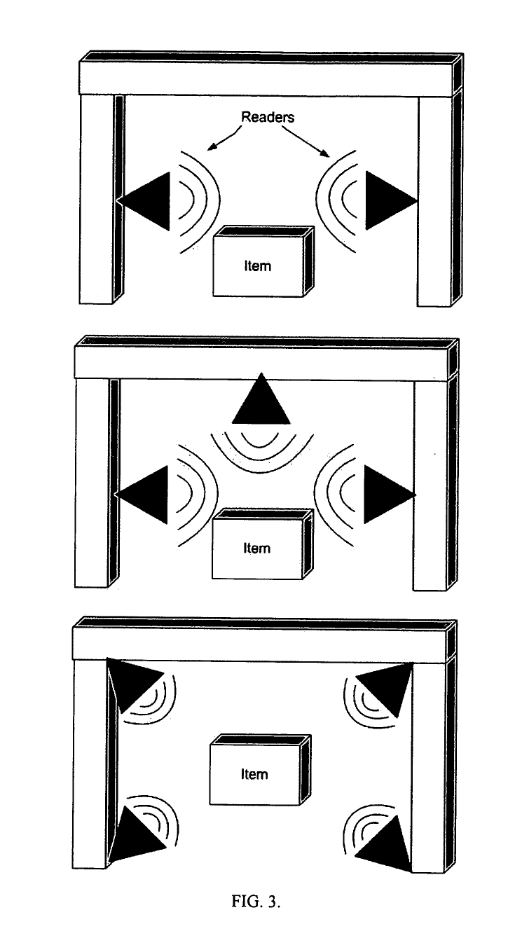

FIG. 3 shows various exemplary RFID reader portals. The readers or interrogators can be mounted on two, three, or four sides of a particular item or package. The RFID reader can interrogate or write data to a tag made up of a microchip with an antenna. Each reader sends out electromagnetic waves. The tag antenna is tuned to receive these waves. A passive RFID tag draws power from the field created by the reader and uses it to power the microchip's circuits. The chip then modulates the waves that the tag sends back to the reader, which converts the new waves into digital data. More readers ensure more wireless paths to the tags.

For example, in a manufacturing environment, RFID tags can be attached to selected items of manufacture or equipment, and at least one RFID reader portal can be deployed in the environment to interrogate the tags as the tagged items pass predefined points on the manufacturing floor. In a typical mode of operation, each reader transmits a radio frequency (RF) signal in the direction of a tag, which responds to the transmitted RF signal with another RF signal containing information identifying the item to which the tag is attached, and possibly other data acquired during the manufacture of the item. The tag may also include at least one integrated transducer or environmental sensor for providing data such as the temperature or humidity level of the ambient environment. The reader receives the information and data transmitted by the tag, and provides the tag data to the host computer for subsequent processing. In this typical operating mode, the reader can be configured as a peripheral connected to a serial port of the host computer.

The RFID readers can connect through a communications network to enterprise computer resources running one or more RFID-enabled client software applications. Such readers have been deployed in complex systems including many readers connected via one or more communications networks to a number of host computers, which may be part of an enterprise network server. Such host computers can run client applications for processing tag data to control access to building and plant facilities, the movement of personnel and property, the operation of lighting/heating/ventilation/- air conditioning facilities, and/or other diverse functions.

Whether implemented as computer peripherals or networked devices, the RFID readers generally collect data from RFID tags much like optical barcode readers collect data from barcode labels. However, whereas an optical barcode reader typically requires a direct line of sight to a barcode label to read the data imprinted on the label, the RF signals employed by the RFID reader can penetrate through and/or diffract around objects obstructing an RFID tag from the RF field of view of the reader, thereby allowing the reader to access data from a tag that, for example, might be buried beneath one or more boxes of merchandise. In addition, unlike the optical barcode reader, the RFID reader can operate on and distinguish between multiple RFID tags within the field of the reader.

Each RFID tag typically includes a small antenna operatively connected to a microchip. For example, in the UHF band, the tag antenna can be just several inches long and can be implemented with conductive ink or etched in thin metal foil on a substrate of the microchip. Further, each tag can be an active tag powered by a durable power source such as an internal battery, or a passive tag powered by inductive coupling, receiving induced power from RF signals transmitted by an RFID reader. For example, an RFID reader may transmit a continuous unmodulated RF signal (i.e., a continuous wave, CW) or carrier signal for a predetermined minimum period of time to power a passive tag. The volume of space within which a reader can deliver adequate power to a passive tag is known as the power coupling zone of the reader. The internal battery of active tags may be employed to power integrated environmental sensors, and to maintain data and state information dynamically in an embedded memory of the tag. Because passive tags do not have a durable power source, they do not include active semiconductor circuitry and must therefore maintain data and state information statically within its embedded memory. In addition, passive tags have an essentially unlimited life span, while the life span of active tags is typically limited by the lifetime of the internal battery, which in some implementations may be replaceable.

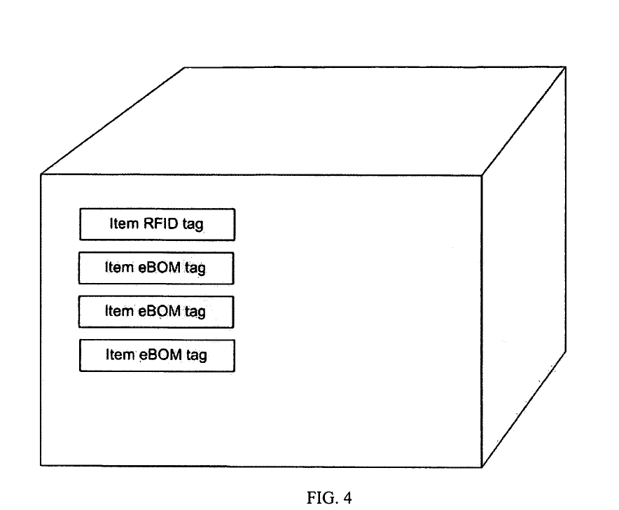

FIG. 4 shows an exemplary placement of tags on an item. In this embodiment, four items, each with its own eBOM tags, are enclosed in a container. The container then enters or exits various tracking stations such as the RFID reader portals of FIG. 3 during its trip.

FIG. 5 shows an exemplary eBOM tag format. In this embodiment, each tag contains an eBOM ID, a next eBOM ID, a digital signature, a type designation, and a series of top-level items and their sub-components.

The eBOM format can include one or more of the following parts:
RFID: The eBOM is also an RFID and therefore requires this
Next eBOM tag: RFID for the next tag of the eBOM, or null if there is none left
Type: This refers to the type of the tag: eBOM or eManifest
Digital Signature: This is used to sign the tag so that the contents cannot be fraudulently altered.
Elements: RFIDs for the item and all the subcomponents

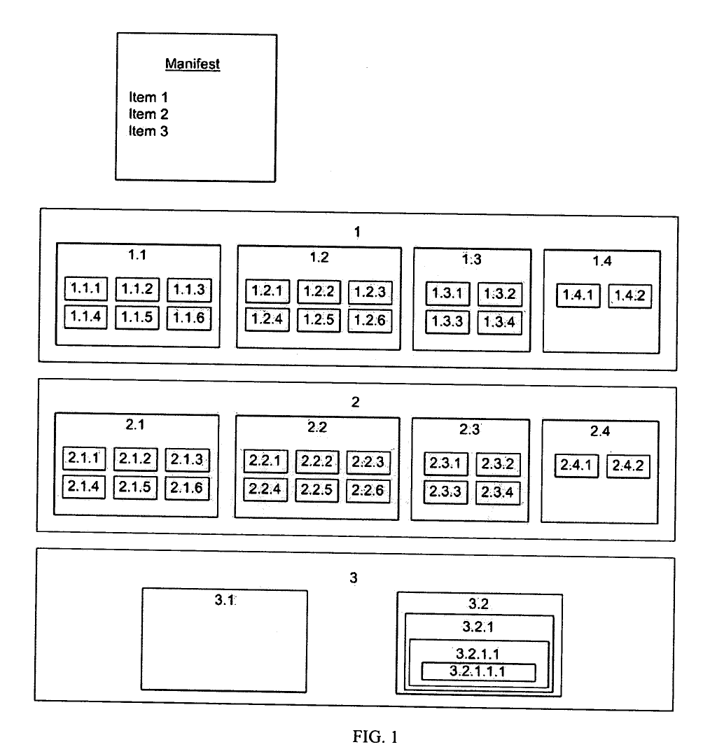

The example shown in FIG. 5 illustrates how the items of FIG. 1 are compiled into 3 eBOM tags. There may be instances where the number of components is too large to fit on a single writable RFID tag. In order to keep the costs low, it might not be desirable to use higher capacity tags or use tags with different capacities. To address this issue, one embodiment provides multiple writable eBOM tags that together form a single logical eBOM, by “linking” each eBOM tag to the next in the logical eBOM using the “next eBOM tag” field. This creates a linked list data structure across multiple eBOM tags. The eBOM tags that together form a single logical eBOM can be physically placed anywhere on the item such as the item of FIG. 4, for example. The “Item RFID Tag” is the original RFID tag placed by the manufacturer or distributor.

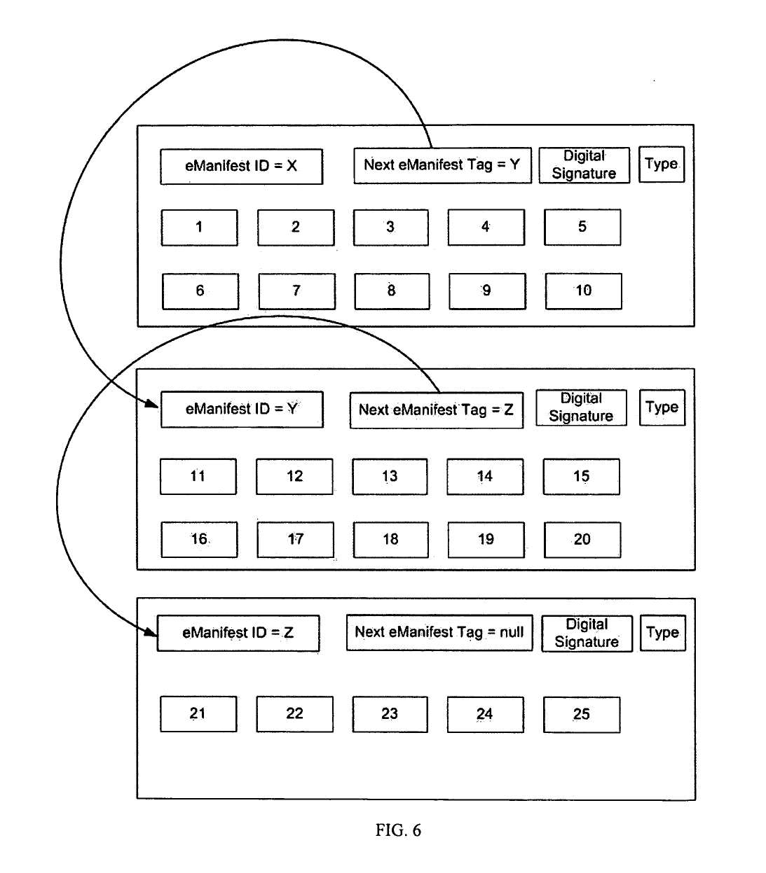

FIG. 6 shows an exemplary eManifest tag format. In this embodiment, each tag contains an eManifest ID, a next eManifest ID, a digital signature, a type designation, and a series of items in the manifest. The exemplary eManifest tag is also an RFID tag. In one embodiment, the format is as follows:
RFID: The eManifest is also an RFID and therefore requires this
Next eManifest tag: RFID for the next tag of the eManifest, or null if there is none left
Type: This refers to the type of the tag: eBOM or eManifest
Digital Signature: This is used to sign the tag so that the contents cannot be altered.
Elements: RFID's for all the top-level items in this manifest

There may be instances where the number of top-level items is too large to fit on a single writable RFID tag. In order to keep the costs low, it might not be desirable to use higher capacity tags or use tags with different capacities. This situation can be resolved in one embodiment by using multiple writable eManifest tags that together form a single logical eManifest, by “linking” or daisy-chaining each eManifest tag to the next in the logical eManifest using the “next eManifest tag” field. This creates a linked list data structure across multiple eManifest tags. FIG. 6 shows an example of how 25 top-level items could be compiled into 3 eManifest tags.

These new eManifest tags that together form a single logical eManifest will be needed to validate the shipment later. They may therefore travel with the shipment, be shipped separately to the destination, carried by the persons responsible for the shipment, etc. In general, it should be placed on the outermost container.

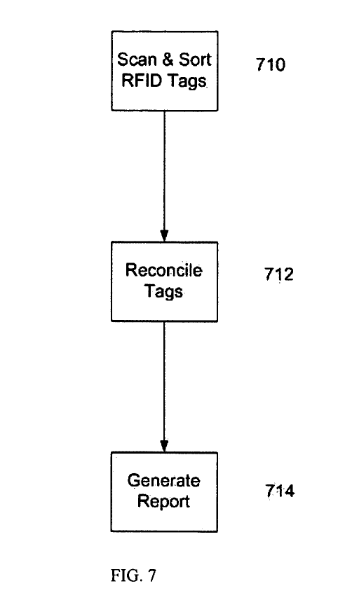

FIG. 7 shows an exemplary validation flowchart. The process first scans the RFID tags (710). Since all tags will be read in a random order, the process sorts the tags so that it can be determined if the shipment has been compromised. The next operation is to reconcile the tags to ensure that everything is accounted for (712). The process then generates a report for any missing or orphaned tags (714). The validation algorithm essentially matches up the items found in the eBOM tags with the top-level items listed in the eManifest. The algorithm is designed to be insensitive to the order in which the scanned eBOM and eManifest tags are processed.

FIG. 8 shows in more detail one exemplary process for sorting tags. A single hash table is created as the data structure to hold all the RFID data. This provides an efficient method of accounting for all the items and components in a single pass.

Turning now to FIG. 8, first, the tag is read (810). The process checks if more tags remain to be read (812). If not, the tags are reconciled (814) and the process ends. Alternatively, if one or more tags remain, the process checks to see if the tag is an eManifest tag (816). If so, the process stores the eManifest data in a register (818) and reads the eManifest elements (820). The process checks if more elements remain (822) and if so, the process checks if the tag exists in the table (824). If the tag exists, the process changes the code to a predetermined value, in this case six, (826) before looping back to 820 to read the next eManifest element. The codes are returned by the sorting algorithm and reported to the query to tell the query generator (such as a user) if there is a problem and what type of problem occurred. Some of these codes are warnings and can be ignored by the user if he chooses; others are errors that need to be dealt with.

From 824, if the tag is not referenced in the table, the process inserts into the table with a second predetermined value of five (828) and loops back to 820. From 822, if no elements remain for the current eManifest tag, the process loops back to 810 to read the next tag.

From 816, if the tag is not an eManifest tag, the process checks to see if the tag is an eBOM tag (830). If so, the process inserts an exemplary value of 7 as a code (832). Next, the process reads each eBOM element (834). The process determines whether additional eBOM elements remain (836). If not, the process loops to 810 to continue reading tags. Alternatively, the process checks to see if the tag has an entry in the table (838). If so, the process checks whether the current element is a top level item (840). If the element is a top level item, the process changes the code to four (842) and if not, the code is set to three (844). From 838, if the tag is not listed in the table, the process checks if the element is a top level item (846). If so, the process inserts the tag in the table and sets the code to one (848) and if not, the process inserts the element into the table and sets the code to zero (850). From 842, 844, 848, or 850, the process loops back to 834.

From 830, if the tag is not an eBOM tag, the process checks if the tag exists in the table (860). If not, the process inserts the tag into the table with a code of two (862), and alternatively, the process checks whether the element is a top level item (864). If so, the process updates the code to four (866) and otherwise the process updates the code to three (868). From 862, 866 or 868, the process loops back to 810 to read the next tag.

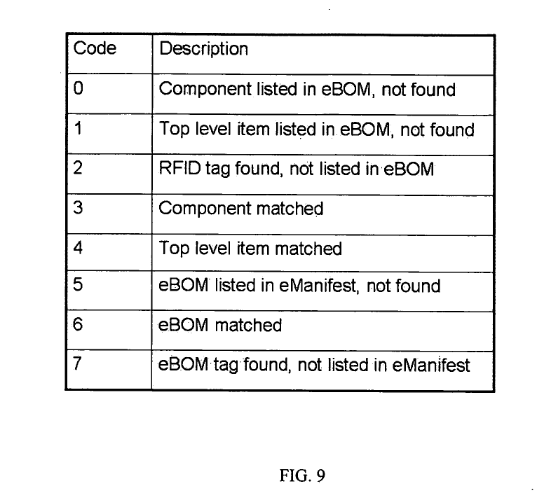

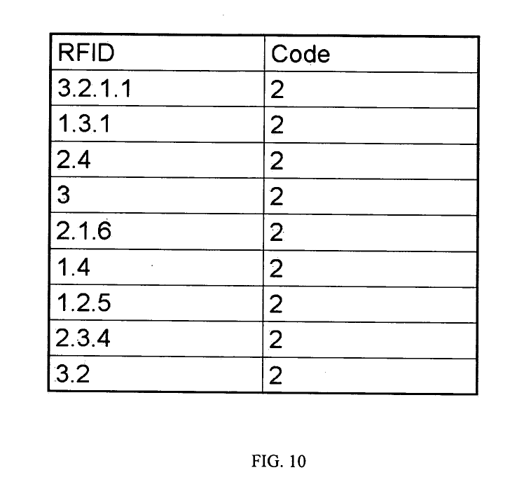

A scan is recorded in the hash table with a specific code according to the code table in FIG. 9 if it does not already exist. An example of this is shown in FIG. 10. If it is, then the code is updated according to the code table in FIG. 9.

If an eManifest tag is scanned, the elements in the eManifest (ie. top level item RFID's) are recorded in the hashtable according to the code table if it does not exist. Otherwise, the entry for that item is updated appropriately.

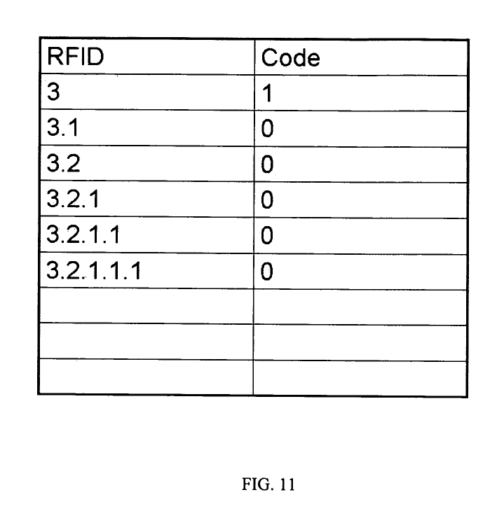

If an eBOM tag is scanned, the elements in the eBOM (this could be the top level item or component RFID's) are recorded in the hash table according to the code table if it does not exist. An example of this is shown in FIG. 11. Otherwise, the entry for that item is updated appropriately.

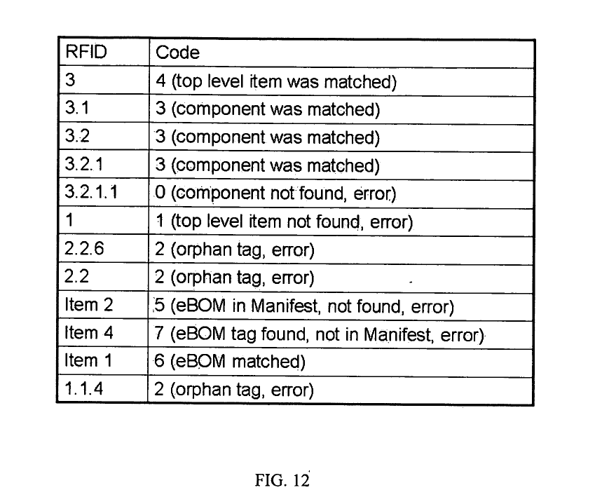

After all the scans are processed, the report is generated by looping through the hash table. An example of this is shown in FIG. 12. In this example, some the components of item 3 have been accounted for (codes have been updated to 3 or 4), while others were not found (code=0, indicating either a failed tag scan or a missing component or high-level item). The report will generate a warning for the missing components. The other RFID's with code 2 were scanned but were not found on any eBOM's or the eManifest. These should be generated as errors.

RFID tags, especially low cost tags, will sometimes fail. If the tag is a component tag, it could be flagged as a warning that can be ignored since the component is unlikely to the removed from the top level item, this is probably due to a failed tag. This is a policy decision that can be configurable. In some cases, it is necessary to report these as errors. If the tag is a top level item and all its components are accounted for, then it might be a failed tag, or the item has been compromised; therefore an error should be raised to alert the user to check the item. If a top level item and all its components are not accounted for, then the item is most likely missing and an error should be raised to alert the user to check for the missing item. If an eManifest tag is missing, then the list of all top level items should be reported. If there is connectivity to the server, then the client should attempt to retrieve the manifest associated with one of the items and account for all the items. If an eBOM tag is missing, then all remaining RFID's not accounted for should be run against the server, if available, to reconstruct the eBOM.

Orphan tags are those that are scanned but not found in any eBOM. These could be extraneous data coming from nearby containers, errors in the RFID reader, or additional items placed in the shipment but not added to the eManifest. They may be flagged as warnings in the final report to the user.

In the embodiments described above, the self-describing nature of the eBOM tags is applied at only one level of the item/subcomponent hierarchy, that is, for the top-level items. If desirable for a given application, self-describing eBOM tags could also be added at any or all lwer levels of the sub-component hierarchy as well.

In the embodiment described above, the eManifest lists only the top-level items, and eBOMs are used to account for the subcomponents of those items. In the case where sufficient storage is available in the technology used for the eManifest, additional levels of the subcomponent hierarchy could be enumerated in the eManifest, reducing the number of levels covered by eBOMs. Taken to the extreme of moving all levels into the eManifest, all items and subcomponents could be listed in the eManifest, and no eBOM tags would be needed.

The sorting algorithm is insensitive to the order in which the tags are scanned. An alternative simpler algorithms can be used if operator is required to follow ordering restrictions, for instance, eManifest tags must be scanned prior to any other tags.

The data structure used to group multiple physical eBOM or eManifest tags into a single logical eBOM or eManifest is a standard singly linked list. The present invention recognizes that other structures distributed across the physical tags could be used as well, such as a doubly linked list. Furthermore, a structure centralized in a single physical device could also be used. For instance, one of the physical eBOM tags could store a simple list of all the physical eBOM tags that make up the single logical eBOM. This idea could reduce the robustness of the invention since that one tag scan could fail, but this problem can be addressed in other ways, such as storing the same simple list redundantly on multiple physical eBOM tags.

The sorting algorithm uses a hash table to maintain the current status of each item and subcomponent as the scans are processed. The present invention recognizes that other data structures could be used in place of the hash table. In fact, any structure can be used that supports insertion and lookup of items at sufficient speed for the application. This could include, but is not limited to, linear sorted lists, lookup trees, and relational or object-oriented databases.

In one embodiment, the sorting process generates a summary report, discarding the raw scan data used to generate the report. In other embodiments, it may be desirable in some applications to also save the raw scan data for purposes of future auditability.

In one embodiment, the eManifest is stored on writable RFID tags. In other embodiments, other local media that could instead store the eManifest, such as printed bar codes, printed matrix codes, flash memory such as USB flash or Compact Flash or Secure Digital, magnetic stripe cards, hard disks, etc.

In yet other embodiments, the eManifest may not be stored locally with the shipment at all, but could be sent to the destination (or other place where the scan is desired) through other communication means such as email or web services, to be stored on a local computer there rather than on removable media.

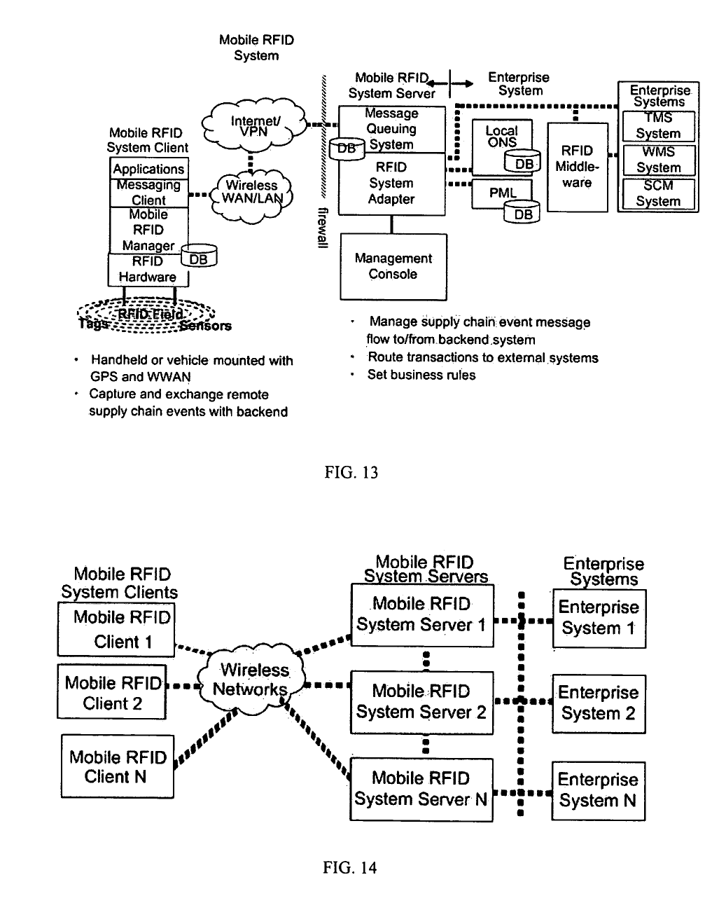

FIG. 13 shows a block diagram of an exemplary mobile radio frequency identification (RFID) system illustrating the components and relationship of the tags to each other, and to external hardware and software system that may be supplied by third parties, among others.

The system has a System Manager 10 which communicates with one or more enterprise systems 30. The System Manager 10 includes a Message Queuing System 12 that provides messaging/transactional services to enable Enterprise Systems and Mobile Systems to be connected over any type of wireless network. It also guarantees message delivery on a once-and-only-once basis and contains persistent data storage in the event the Mobile becomes disconnected from the Mobile System. The Wireless Platform includes both servers-based components and mobile device-based components. The System Manager 10 also includes an RFID System Adapter 14 that serves at the point of integration between the Mobile RFID System and Enterprise Systems 30. The Manager Queuing System 12 and the RFID System Adapter 14 store information in a database 16.

In one embodiment, the System Manager 10 is server-based system software that runs on a variety of industry server platforms. It stores and executes business rule as defined by system administrators through a Management Console 20. In one embodiment, the Management Console is Browser-based application software that enables system administrators to enter and update a variety of parameters that the System Manager 10 uses to control the Mobile RFID System. The Management Console 20 includes Business Rules that allows a system administrator to enter business rules through a series of screens to be executed by the System Manager 10. The Management Console 20 also allows a system administrator to enter automated asset reporting parameters to be executed by the System Manager. The Console 20 also allows a system administrator to enter automated alert parameters to be executed by the System Manager. The Console 20 also allows the enterprise systems 30 to query the status of assets.

In another embodiment, a Web Service provides a primary interface to the Mobile RFID System. The Web Service allows Enterprise Systems 30 to send commands and requests and in return receive status information back. It allows Enterprise Applications to set configurations of alerts conditions, reporting rules, and to query the status of specific assets and environments. Configuration settings are stored in Configuration Tables. Examples of operations done through the Web Service include:
1. Send an alert to the Enterprise System if asset(s) are removed from the RFID Field
2. Send an alert to the Enterprise System if asset(s) are removed from the RFID Field while the RFID Field is outside a particular geographic region (as defined by a geo-fence, which may be a GPS location and a specified radius around that location).
3. Send and alert to the Enterprise System if the average temperature of the environment in which the asset is contained exceed X degrees.
4. Automatically report the location of the asset(s) every X hours.
5. Immediately report the location of the asset(s).

A Mobile RFID System Client 40 is a system running on a variety of industry standard handheld device platforms. An application 42 runs on the Mobile RFID System Client 40 to support inventory or asset management applications, for example. The application communicates with a Mobile Application API 44 which supports a range of functions including, but not limited to:
1. Scan EPC tags in the immediate RFID field and return EPC code data;
2. Scan sensor tags in the immediate RFID field and return requested data according to sensor type, e.g., current temperature inside a container, temperatures recording over a specific period, or maximum and minimum temperatures that the container has been subjected to.
3. Write EPC data to a tag.
4. Set parameters in the Mobile RFID Manager to trigger alerts based on pre-set conditions occurring in the RFID Field.

The Client 40 works in conjunction with a Messaging Client 46 to provide applications with programmatic access to local onboard or local area wireless RFID devices, and to remote servers and enterprise systems over a variety of wireless network types. An RFID Manager 47 serves as the central access point in the Mobile Device to provide asset visibility and monitoring services to applications through the API 44, uses connection services provided by the Wireless Platform to communicate with Enterprise Systems 30, and an interface to the RFID Manager 47. A module accessible through the Mobile RFID Manager 47 monitors and controls read and write functions in an attached RFID Field. Action may be driven by local Mobile Applications 42, remote Enterprise Systems 30, or settings in Configuration Tables.

A Message Client 46 runs on the mobile/handheld device to provide messaging and or transactional communications over any type of wireless network to the Message Queuing System 12. It provides message delivery on a once-and-only-once basis and contains persistent data storage in the event the Mobile becomes disconnected from the server side of the Message Queuing System 12. The Messaging Client 46 communicates with a wireless WAN or LAN 50, which in turn communicates over the Internet 60 with the Mobile RFID System 10. The communication can occur over a virtual private network (VPN) and a firewall to provide secure communication.

The RFID hardware 48 communicates with RF tags or sensors. The RF tag receives signals from and transmits signals to RFID/RFDC hardware 48 over a communications path. The RF tag is preferably passive but may be active, if desired. When the RF tag receives an interrogation signal, the RF tag may or may not send a response signal. RFID hardware 48 may be able to interrogate an individual, some, or all RF tags or sensors. The RF tags or sensors may contain memory such as read only memory (ROM), random access memory (RAM), flash memory, Erasable Programmable Read Only Memory (EEPROM), or the like which stores information. For example, the RF tag may contain a preamble message code that may contain a code specific to RF tags, and/or the asset or location associated with RF tags. The RFID hardware 48 may be able to address specific RF tags by using codes in the interrogation signal. RFID hardware 48 may also be able to modify the content of the memory of a specific RF tag. Such memory modification may be particularly useful when a particular RF tag is initially associated with an asset. This may be done, for example, by allowing an asset code to be entered and stored in the RF tag. The RF tags or sensors may also be individually addressable based on the frequency of the interrogation signal or by any other suitable method (e.g., unique addresses). Alternatively, RF tags or sensor may send response signals that are specific to a particular RF tag, sensor and/or the asset or location associated with the RF tag or sensor. The response signals from separate RF tags or sensors may be distinguishable by their frequency, a time delay, unique identifier, or by any other suitable method.

FIG. 14 shows an exemplary Mobile RFID System with Nodes 40A-40C communicating over the Wireless Network 50 to one or more Mobile RFID System Servers 10A-10C. The System Servers 10A-10C in turn communicate with their respective Enterprise Systems 30A-30C. FIG. 14 illustrates a scenario with multiple interconnected Mobile RFID System Clients 40A-40C, some of which may be dynamically “occasionally connected” and resident in mobile devices 40A-40C. Others may be statically “always connected” and resident in enterprise servers 30A-30C. The nodes 40A-40C work together to maintain consolidated asset data accessible from the Mobile System Servers 10A-10C.

In one implementation, a query is received by the Mobile RFID System through the Mobile RFID System Web Service. The Mobile RFID System Manager checks the Business Rules for the asset(s) and performs the appropriate query on the local database and, if necessary, the Mobile RFID System Client nearest to the asset(s). If the requested data is available locally, a response is sent to the Enterprise System. If a request is made to a remote Mobile Device, the device is contacted and responds with the requested data. The Business Rules are automatically executed on the Mobile Device to report asset status and location to the Mobile RFID System Manager. In the event that the Mobile Device is temporarily outside of wireless network coverage, the data destined for the Mobile RFID System Manager is queued in the Messaging Client component of the Mobile RFID System Client until network coverage resumes.

The system consists of items that move from node to node. Supporting this is a set of servers that track the items and nodes. An item is an individual entity that is identified with a unique identifier (typically an RFID tag, or barcode). The identifying tag must be readable remotely and automatically so that it can be queried even if there is no human presence. This can be achieved by ensuring that items are placed in locations that have a network of readers that can reach all the items. A mobile node is a vehicle that transports the items, eg. truck, train, ship. It does not require much persistent data storage; only limited storage is needed for caching data; it does not have to store the ID's for all the items (although it can). Item ID readers are mounted on a vehicle, which allow them to dynamically query for the presence of an item. Mobile nodes receive queries from the static node that forwarded the item to locate it using its ID tags. A static node is an intermediate storage place for the items, eg. warehouse, crossdock, distribution center. It stores information about all items currently in its location or being forwarded to another location (but not reached the destination yet). The information is stored on a computer system with sufficient disk storage for all items currently located at its premises. The computer system interfaces with readers that can reach all items. The computer system must be attached to a network that reaches its server. A terminal node is an end point or port to locations outside the system, eg. a factory, shipping port, airport. The information is stored on a computer system with sufficient disk storage for all items currently located at its premises. The computer system interfaces with readers that can reach all items. The computer system must be attached to a network that reaches its server. For static and terminal nodes, the information about items can alternatively be stored on the servers instead of its own computers.

Security is an important aspect of this system because of the nature of supply chains. Various partners in intersecting supply chains might have adversarial relationships and do not want information shared with opposing partners. For instance, two suppliers A and B might use the same carrier (e.g., UPS logistics) to take care of their shipping needs. They do not want each other to view where their items are in the shipping process as this information might provide invaluable competitive information (e.g., destinations, quantities). It is therefore important to protect the privacy of the information. The two aspects of security addressed in this system are authentication and authorization. Authentication is enforced between the servers and nodes. A node has to log into its assigned server each time it connects. This can be done using the usual methods of authentication, for example an account ID and password. Data encryption can be implemented using standard techniques such as public-key encryption and X509 digital certificates, for example. Because the system is automatically tracks the location of items, it cannot require a user to manually authorize every transaction. Instead, the system makes an implicit assumption that the origin static/terminal node is authorized to query the location of an item that is sent to a destination static/terminal node, since obviously it had to know where the item was going. For example, if an item was sent from node A to B and then to C, node A is authorized to query the location of that item between A and B (including all the mobile nodes used in between the nodes). Node B is then authorized to query for the item when it travels between B and C. Therefore, node A can query node C and any subsequent node. This is called authorization forward chaining and can be done automatically. A node can override this by breaking the chain at its location although this is not recommended as the visibility of an item's location is curtailed at that node. To overcome objections for sharing the information, the system defaults the information to only the location coordinates (latitude, longitude) of the item and the arrival date and timestamp. It does not give away the identity of the node, which might be considered confidential, for instance if a third-party logistics (3PL) provider does not want its customers to know which carriers it uses to transport the items.

In one embodiment, new nodes are registered with the system. The system includes one or more registration servers and one or more communication servers (or home servers) that talk to each node. The registration process is as follows:
Step 1: When a static or terminal node is brought on line, it first registers itself to the registration server. The registration process creates a unique account ID and password for the node. The registration server then assigns the new node to its home server to which is must now connect for any transactions. The registration server returns the location of the home server to the node.
Step 2: The registration server transfers the credentials (account ID, password) to the home server so that when the node connects to the home server, it is able to log in.

Node to Server Assignment is done so that a node is assigned to only one server and must communicate with other nodes through its server. When a node has been registered, it then needs to connect to its home server as follows:
Step 1: Nodes N1, N2, N3 are assigned to server A and will only communicate with Server A. They each login with their respective account ID's and passwords to server A. Nodes N4, N5 are assigned to Server B and will only communicate with server B. They each login with their respective account ID's and passwords to server B. If node N4 tries to log into server A, it will not be authenticated. However, if a node wishes to make a query, this is sent to the registration server instead of the home server because the registration server keeps the list of all the home servers to which it will broadcast the query. This will allow new home servers to be added at any time.
Step 2: Any communication between nodes on different home servers goes through the home servers. For example, if node N2 wants to talk to node N5, it first talks to server A, which transmits the transaction to server B, which then forwards it to node N5. Even if a node is talking to a node connected to its home server, it must always go through the home server. For instance, if node N1 wants to talk to node N2, then it must send the transaction via server A. This procedure is done since nodes might be reassigned over time to balance transaction loads and therefore hard links between nodes are not established to provide this flexibility.

All nodes (mobile, static, terminal) are registered in the same manner. A node can be unregistered by connecting to the registration server and sending a request to terminate its account. Once this is done, it cannot connect to its home server anymore. In order to reestablish itself in the system, the node must register again as a new node.

An item can appear anywhere in the system. It must be associated with a node where it originated. This can be a static, terminal or mobile node. Typically, an item appears in a system at the factory where the item is manufactured, which is a terminal node. However, some factories are not part of the system, so the item is created at a mobile node on which the item is shipped, or a static node (like a logistic company's warehouse).
Step 1: Item X is appears at node N1. A new record for the item is created at node N1.
Step 2: N1 informs its home server A of the creation of item X. Server A creates a new record for item X

In one implementation, the item record on the node consists of the following:
Item ID (primary key)
Arrival date and time
Departure date and time
Mobile node ID to which the item has been forwarded
Shipment ID: this is a unique ID that is automatically generated for all items that have been forwarded to a mobile node.
Last known position: this is returned from a ping of the mobile node onto which the item was loaded
Status: On site | Transit | Consumed | Missing (other status fields can be added later)
Attachments. The node can add other data fields it wishes to associate with this item. For example, if it wants to track the current temperature or barometric pressure reading, this can be added here.

In an implementation, the item record on server consists of the following:
Item ID (primary key)
Current location: Node account ID
Current location: GPS LAT/LONG
Authorization List: (FIFO order) eg. N1, N2, N3, N4, N5
Arrival date/time at location
Status: On site | Transit | Consumed | Missing (other fields can be added later)
Attachments

The records created on the nodes and servers are similar. For this reason, nodes that do not have a large data storage capacity can delegate the responsibility for storing the information about each item on its home server by adding the additional fields. This will increase the number of transactions because the home server will now receive positional updates for the item, which used to get stored only on the node.

When an item is transferred from one a static or terminal node to a mobile node, the following process for an item transfer from a static/terminal to a mobile node is done in one embodiment:

Step 1:
Item X is loaded onto mobile node M (eg. truck, train)
Item X's record on node N3 is updated to reflect that item X has been loaded onto mobile node M

When an item is transferred off a mobile node to a static or terminal node, one exemplary process for transferring an item from a mobile to a static/terminal node is as follows:
Step 1: Item X is unloaded from mobile node M to static node N4 (which could also be a terminal node)
Step 2: Node N4 checks for record of item X. If it is found (eg. damaged item returned to warehouse), then it updates its record that item X is in its location. If record of item X is not found, then it must talk to its server to have the record transferred over. See scenario “Item Record Transfer”.

In a process for transferring an item record between servers, an item record is stored in the home server associated with the node where the item is physically located. If that item has been moved to another node that belongs to a different home server, then the item record is transferred to the new home server.
Step 1: Item X is transferred from node N3 to node N4
Step 2:
   Item X is recorded at N4 with a date and time stamp
   N4 sends to its server B:
      a. Item ID tag information for X
      b. Arrival date and time
      c. GPS location for N4
Step 3:
   Server B:
      Does not find record of item X
      Sends a broadcast to other servers
Step 4:
   Server A returns record of item X
   Server B creates new record for item X and adds N4 to authorization list behind N3
   Server A deletes record for item X after receiving acknowledgement from server B that it has been recorded (transaction semantics)
Step 5:
   Server A notifies node N3 that item X has been transferred
   Node N3 deletes record of item X from its database

To query the location of an item located at a static or terminal node, an item query should come from a static or terminal node and not a mobile node because only these are stored on the authorization list of the item record.
Step 1:
   Node N1 makes a query of location of item X to registration server. The reason that it sends the query to the registration server
Step 2:
   Registration Server broadcasts query to all servers
Step 3:
   Server B has the record of item X and checks for authorization of node N1 to get location information. Assuming that item X was originally sent from N 1, then the record will have N1 and therefore authorization will be granted.
   Server B then queries N4 where the item X was last located and receives a response from N4 that item X is still at its location
Step 4:
   Server B sends a message to N1 with the GPS location and arrival date/time of Item X

During the processing of an item query to a mobile node, an item query must come from a static or terminal node. Note that the node does not need to know that an item is on a mobile node, it simply invokes a query for an item given the item's unique ID.
Step 1:
   Node N1 makes a query of location of item X to registration server
Step 2:
   Registration server broadcasts query to all servers
Step 3:
   Server B has the record for item X and checks for authorization of node N1 to get location information. Assuming that item X was originally sent from N1, then the record will have N1 and therefore authorization will be granted.
   Server B then queries N4 where the item X was last located
Step 4:
   Node N4 checks its records and realizes that item X has been forwarded on mobile node M, so it sends the query to M.
   Mobile node M receives the query and checks authorization. Only the last static node that forwarded the item is allowed to check status. M verifies that node N4 was the last static node and queries for Item X.
   Item X is found on mobile node M, so mobile node M replies to static node N4 that item X has been found with current location and date/time.
Step 5:
   Node N4 replies to server B with location information of item X
Step 6:
   Server B sends a message to node N1 with location information of item X

When an unauthorized query is made for the location of an item, the system cannot assume that all queries for items are authorized. In the example of an unauthorized item query, assume item Y was delivered to node N3 from node N4, and did not go through N1 or N2. Therefore, according to our authorization forward chaining rule explained earlier, node N1 is not authorized to query about the location of item Y.
Step 1:
   Node N1 makes a query for the location of item Y
   The query is sent to the Registration Server
Step 2:
   The Registration Server sends the query to all the servers
Step 3:
   Server A finds a record for item Y and checks if node N1 is on the list of nodes that item Y has passed through. Since it has not, server A replies to node N1 that it is not authorized to get the information.

When an item is delivered to a terminal node and is moved out of the system where it cannot be tracked any further, it must be marked accordingly so that queries can be properly returned. The process to handle the item consumption scenario is as follows:
Step 1:
   Item X is consumed at node N5
   Eg. Item X is a part that is used to manufacture a product
   N5 records arrival for item X
Step 2:
   Node N5 sends information to server B
      Action=CONSUMED
      Date/Time of arrival
   Server B
      Marks Item as consumed at N5
      Keeps record for a while before deleting. This should be configurable

This system continuously tracks the locations of all items by sending a ping from the origin node to the mobile node. Since most shipments consist of many items, sometimes numbering in the thousands or even millions, it is inefficient to monitor every single item's location. When an item is loaded onto a mobile node, it is assigned a shipment ID, which is a unique ID that is automatically generated by the origin node. The system first checks for other shipments on the same mobile node on the same date and within a similar window of time. If so, it assumes that the item is on the same shipment and assigns it the same previously generated shipment ID. A static node constantly checks item location by running through its set of active shipment ID's and pings the mobile node to check for an item's location. A mobile node returns with its current location and whether the item is still there as well as the current location coordinates. If not, it will return the destination nodes' ID. A ping should query for random item ID's on the mobile node to ensure the integrity of the shipment because items might be removed off the mobile node. If a mobile node is out of coverage, multiple pings might be queued up on the static node and sent when the mobile node is back in coverage. Multiple pings are discarded and only one response is sent back. This offers an optimal method for tracking all the items without unnecessary queries.

Exception Management is built into the system in the following cases:

Item ID tag failure
Item ID tag reader failure
Item ID tag obscured from reader
Item ID routed to location with no reader
Pilferage
Damage

The static node forwards an item retains that item's record until it has been positively acknowledged by the destination node. This is similar to a transaction semantic that requires an acknowledgement before committing that transaction. In the case where any of the exceptions listed above occurs, then the item record remains open. By continuously monitoring the location of an item, the system will know if there is a problem and can therefore trigger an exception management action, such as sending an alert to the administrator at the originating node to investigate the discrepancy.

An alert can be sent if the destination node did not report an item's expected arrival. If an item is loaded off a mobile node into a static node, then the static node should create a record for the item and update the server, which will inform the origin node. Since the origin node is constantly pinging the mobile node, if the mobile node indicates that the item has been offloaded but the destination node has not reported its arrival, then an alert should be sent to the origin and destination nodes informing them of the discrepancy. The origin node then sends a query to the server which will broadcast it to all static nodes. If any node has received the item, then the records on the origin and destination nodes are reconciled automatically. If not, then the origin node will list the item as missing. Note that because the system does not know the destination node of an item a priori, it cannot query the destination node with regards to the location of that item. It can only wait until the pings to the item have failed after several successive attempts.

In one aspect, systems and methods are disclosed to track first and second nodes equipped with radio frequency identification (RFID) tag readers by registering a first node and a second node with a registration server; assigning the first and second nodes to first and second home servers respectively, wherein the first node is authorized to communicate with the first home server and the second node is authorized to communicate with the second home server; and for each query requested by each node, sending the query to the registration server to be broadcasted to the home servers.

In a second aspect, a system to track first and second wireless nodes includes a network; first and second home servers coupled to the network and communicating with the first and second wireless nodes, respectively, wherein the first node is authorized to communicate with the first home server and the second node is authorized to communicate with the second home server; a registration server coupled to the network and adapted to assign the first node to the first home server and the second node to the second home server; and an enterprise computer coupled to the network to query the nodes.

Implementations of the above two aspects may include one or more of the following. The system allows data to be communicated between the first and second nodes by sending data from the first node to the first home server, sending data from the first to the second home server, and sending data from the second home server to the second node. The system authenticates each node. The authenticating can include submitting an identification and a password. The nodes can include a static node, a terminal node, or a mobile node. The system communicates node data over multiple, disparate, and intermittently connected wireless networks. The system can determine a physical location or an environmental status of a node. The system can include monitoring of assets such as a vehicle, a container, an equipment, or inventory. The system performs a bi-directional transmission of requests from, and replies to, applications containing commands, and status and location data. The system can performs authorization forward chaining. The system can communicate only node location and date information to preserve privacy, or the system can communicate identity of the asset as well.

In another aspect, a system is disclosed for tracking and monitoring the location and/or status of assets that are in transit, including attributes of their surrounding environment. To track an asset in the context of the present invention is to verify its past, present, and projected future locations anywhere on the planet. To monitor an asset is to verify its status relative to a known location or locations, such as a defined geographic boundary. For the purposes of this description, status may refer to the presence of absence of an asset, state of an asset (e.g., on, off), or attributes or environment in which the asset resides (e.g., temperature, pressure, moisture, speed, direction, radiation, chemicals). An asset may be an item, group of items (hierarchy), container (box, palette, etc.), vehicle (truck, rail car, etc.), or equipment (tools, machines, etc.).

In yet another aspect, a system provides automatic tracking and monitoring of assets regardless of location and without continuous wireless network coverage. The system elements described herein include, but are not limited to, a Web Service for programmatic access to the system, a system manager function for single point of access to myriad interconnected fixed and mobile RFID nodes, a multi-channel wireless platform for guaranteed communications, a plurality of mobile computing devices, a plurality of fixed mobile or handheld mobile RFID transceivers, and a plurality of assets equipped with RFID tags and/or environmental sensors.

In one embodiment, the system provides an asset tracking and monitoring system having: a) an RFID reader equipped with local area wireless communications (e.g., BlueTooth or WiFi) in a fixed position inside a vehicle or shipping container; and b) a mobile or fixed handheld computer equipped with local area and wide area wireless communications software and hardware; a plurality of assets equipped with RFID tags capable of EPC data storage and/or environmental sensing (e.g., temperature, humidity, CO2); d) a server computer with connections to wireless networks; and e) server software and hardware that manages the flow of data between mobile assets and backend enterprise systems.

Another embodiment of the present invention provides an asset loading/unloading system. The system is composed of: a) an RFID reader equipped with local area wireless communications (e.g., Bluetooth or WiFi) in a fixed position near the doors of a vehicle, shipping container, or loading dock; and b) a mobile or fixed handheld computer equipped with local area and wide area wireless communications software and hardware; a plurality of assets equipped with RFID tags capable of EPC data storage and/or environmental sensing (e.g., temperature, humidity, CO2); d) a server computer with connections to wireless networks; and e) server software and hardware that manages the flow of data between mobile assets and backend enterprise systems.

Although specific embodiments of the present invention have been illustrated in the accompanying drawings and described in the foregoing detailed description, it will be understood that the invention is not limited to the particular embodiments described herein, but is capable of numerous rearrangements, modifications, and substitutions without departing from the scope of the invention. The following claims are intended to encompass all such modifications.

What is claimed is:

1. A method to track items transported in a container, comprising
caching relationships among one or more items of the container by writing the relationships on a memory attached to that container;
shipping the container to a destination; and
at the destination, scanning the memory to determine whether the transported one or more items arrived at the destination.

2. The method of claim 1, comprising validating shipments of items in a single-pass as the shipment moves through an RFID scanning portal.

3. The method of claim 1, comprising accounting for receipt of shipped items.

4. The method of claim 1, comprising listing missing items during shipping.

5. The method of claim 1, wherein a shipment comprises one or more top-level items.

6. The method of claim 5, wherein the shipment comprises one or more hierarchically organized sub-components of the items.

7. The method of claim 6, wherein the hierarchy mirrors a physical arrangement of the items.

8. The method of claim 1, comprising generating a self-describing hierarchical RFID tag structure

9. The method of claim 1, wherein the structure comprises a linked-list data structure for multiple RFID tags, wherein the data structure is used for managing electronic bills of materials and electronic shipping manifests.

10. The method of claim 1, comprising generating an exception in response to an RFID tag read failure.

11. A method to track items transported in a container, comprising
determining a relationship among one or more items and zero or more sub-components of each item;
writing the determined relationship to a first tag attached to the item;
aggregating the one or more items and the zero or more sub-components of the item into one shipment; and
writing a second tag describing all items and attaching the second tag to the shipment.

12. The method of claim 11, wherein the tag comprises an electronic bill of material (eBOM) tag.

13. The method of claim 11, wherein the second tag comprises an electronic manifest (eManifest) tag.

14. The method of claim 11, comprising validating shipments of items in a single-pass as the shipment moves through an RFID scanning portal.

15. The method of claim 11, comprising accounting for receipt of shipped items.

16. The method of claim 11, comprising listing missing items during shipping.

17. The method of claim 11, comprising generating a self-describing hierarchical RFID tag structure

18. The method of claim 1, wherein the structure comprises a linked-list data structure for multiple RFID tags, wherein the data structure is used for managing electronic bills of materials and electronic shipping manifests.

19. The method of claim 11, comprising:
registering a first node and a second node with a registration server;
assigning the first and second nodes to first and second home servers respectively, wherein the first node is authorized to communicate with the first home server and the second node is authorized to communicate with the second home server; and
for each query requested by each node, sending the query to the registration server to be broadcasted to the home servers.

20. A system to track items transported in a container, comprising:
a network;
first and second home servers coupled to the network and communicating with first and second wireless nodes, respectively, wherein the first node is authorized to communicate with the first home server and the second node is authorized to communicate with the second home server; the first node caching relationships among one or more items of the container by writing the relationships on a memory attached to that container; shipping the container to a destination; and at the second node, scanning the memory to determine whether the transported one or more items arrived at the destination;
a registration server coupled to the network and adapted to assign the first node to the first home server and the second node to the second home server; and
an enterprise computer coupled to the network to query the nodes.

21. The system of claim 20, comprising:
a mobile computer coupled to one of the home servers;
a radio frequency identification (RFID) reader; and
a plurality of assets equipped with RFID tags.
